(19) United States
(12) Patent Application Publication
(10) Pub. No.: US 2004/0250615 A1
(43) Pub. Date: Dec. 16, 2004

(54) Device and method for determining the muzzle velocity of projectile

(75) Inventors: Aldo Alberti, Winterthur (CH); Klaus Munzel, Klingnau (CH)

Correspondence Address: MCCORMICK, PAULDING & HUBER LLP, CITY PLACE II, 185 ASYLUM STREET, HARTFORD, CT, 06103, US

(73) Assignee: Oerlikon Contraves AG, Zurich (CH)

(21) Appl. No.: 10/854,529

(22) Filed: May 26, 2004

(30) Foreign Application Priority Data
May 28, 2003 (CH) CH 2003 0961/03

(51) Int. Cl. G01L 5/14

(52) U.S. Cl. 73/167; 42/106

(57) ABSTRACT

A device (10) and a method for determining the muzzle velocity (V0) of the projectile (1) upon exiting a weapon barrel (11). The device (10) includes a coil (12), which is positioned around a longitudinal axis (11.1) of the weapon barrel (11) in the region before the exit, and a supply device (15) for impressing a current (I) in the coil (12) to generate a magnetic field (H). The device (10) additionally includes an analysis device (16), which reads off a voltage pulse on the coil (12), induced during the passage of the projectile (1) through the magnetic field of the coil (12). Two predetermined points of the voltage pulse are detected, the time interval between the two points is determined, and the muzzle velocity (V0) of the projectile (1) is calculated from the time interval.

### FIELD OF THE INVENTION

The present invention relates to a method for determining the muzzle velocity of a projectile and a method for determining the muzzle velocity of a projectile utilizing a coil positioned along the longitudinal axis of the weapon barrel.

### CROSS REFERENCE TO RELATED APPLICATION

The disclosure of Swiss Patent Application 2003 0961/03 of May 28, 2003, from which priority is claimed, is incorporated by reference.

### BACKGROUND OF THE INVENTION

The muzzle velocity of a projectile is typically referred to in gunnery as V0 and also as V0 velocity. This is the velocity at which the projectile fired from a barreled weapon moves on its trajectory in relation to the weapon barrel upon exiting the weapon barrel.

In the framework of the present description, the term weapon barrel is to be understood to mean both cannons and rocket launching tubes. The term projectile is to be understood as all missiles which may be fired out of a weapon barrel, i.e., ballistic projectiles and projectiles that are at least partially self-propelled. Ballistic projectiles are understood as typical shells which detonate upon impact, as well as settable and/or programmable shells which detonate in flight, for example. The projectiles may be spin-stabilized and/or fin-stabilized, they may be implemented, for example, as sabot shells, as primary shells which guide multiple secondary shells with them, or as practice shells having a core and mantel.

Among other things, the duration of flight, the firing distance, and the point of impact position are a function of the V0 velocity. The precise knowledge of the muzzle velocity V0 is, however, particularly important in connection with programmable projectiles, since the point of time of the transmission of a programming code to a projectile for the purpose of achieving the desired weapon effect is a function of the muzzle velocity V0. The muzzle velocity V0 is also a function of the weight and the temperature of the propellant charge.

A theoretical muzzle velocity V0(theor) may be calculated using a computer if all data relevant in this regard which concerns the weapon and/or the weapon barrel and the projectile to be fired is known. In reality, the muzzle velocity V0 almost always deviates from the theoretically calculated muzzle velocity V0(theor), among other things because both the weapon and/or the weapon barrel and the projectile do not correspond precisely with the data upon which the calculation is based. In particular, the V0 velocity is reduced as a result of the wear of the weapon barrel. It is therefore necessary to measure the actual muzzle velocity in each case upon firing in order to possibly correct the azimuth and elevation of the weapon barrel in regard to the target to be combated and/or to program the projectile or at least the following projectiles appropriately.

Different devices and methods are known for measuring the actual V0 velocity. The measurement of the V0 velocity is frequently based on a barrier principle. Such a V0 measurement is known from EP-0 108 979-A1. In this case, two coils are used, which are positioned at a known mutual distance and, viewed in the flight direction, after the exit cross-section of the weapon barrel. These coils and/or their mutual distance form a measurement baseline. The coils are generally positioned at least approximately concentrically to the longitudinal axis of the weapon barrel, and their internal diameter is somewhat larger than the caliber of the weapon barrel. The coils are applied to current sources, so that a magnetic field results in the region of each coil and an induced voltage may be read off upon passage of the projectile. While a projectile flies through the region of the coils, the magnetic field is disturbed and the readable voltage changes as a function of the position of the projectile in relation to the coils.

This previously known double-coil device for V0 measurement has several disadvantages, of which the most important are to be cited briefly in the following. The device has a comparatively high weight and a large volume due to the arrangement of two coils. The outlay for additional devices is also relatively large because of the arrangement of two coils, since an analysis channel is necessary for each coil. Furthermore, the device must have a specific length for a precise V0 measurement, since the distance of the coils is determined by, among other things, the length of the particular projectile to be fired. Therefore, if long projectiles, such as subcaliber shells, are also to be fired from a weapon barrel, the coils are to be spaced further from one another, the second coil in particular being spaced far from the weapon barrel muzzle. The coils may be damaged easily in any case, and the danger of damaging the coils increases the further they are spaced from the weapon barrel. If one intends to fire subcaliber ammunition, complex constructive measures must be taken in order to prevent damage to the coils by the sabot components, which detach from the actual projectile directly after firing. If only short projectiles are to be fired, a long measurement baseline is not necessary, and the coils may be positioned at a relatively small distance from one another. However, in this case the danger arises that the two coils will influence one another in regard to the electromagnetic effects playing out in their region and thus prevent precise V0 measurement, or make such a measurement require a complex apparatus.

A device for performing a V0 measurement, in which only one single coil is used instead of two coils, is known from Patent Application GB-2 200 215. This coil is positioned directly in front of the muzzle cross-section. Therefore, it is around and/or on the weapon barrel and has a current applied to it, so that a magnetic field arises in the region of the coil. As in the double-coil device described above, an induced voltage which changes over time is read off as the projectile passes through the coil. Using this single-coil device, certain disadvantages of the double-coil device are avoided, particularly its relatively large dimensions and weight, the danger of damage is practically eliminated, mutual interference of multiple coils is prevented, and only one analysis channel is necessary. However, this device has the disadvantage that in this case the magnetic field through which the projectile moves is disturbed by the weapon barrel. Furthermore, very high temperatures up to 600° C. arise on the weapon barrel in modern weapons. Coils having windings made of copper, as are preferably used, may not be used in an arrangement on the weapon barrel, since they are only usable at temperatures up to approximately 250° C. It is a further disadvantage of this arrangement that the magnetic field of the coil is disturbed and damped by the weapon barrel. Such an arrangement therefore has a reduced sensitivity. The induced voltage has a smaller amplitude and the analysis of such a “small” signal is imprecise.

Furthermore, a device for performing the V0 measurement, which also has only one coil, is known from JP-05 164 760. The coil is, as usual, positioned coaxially to the weapon barrel, but it is located in the weapon barrel itself, close to the exit cross-section of the projectile, when viewed in the direction of the weapon barrel longitudinal axis. The internal diameter of the coil is larger than the internal diameter of the weapon barrel, so that the otherwise continuous cylindrical inner surface of the weapon barrel is interrupted by an air gap at the location of the coil. The projectile to be fired has a ferromagnetic ring around its circumference. The axial length of the air gap and/or of the ferromagnetic ring forms the measurement baseline. The curve of the change of the magnetic field of the coil is measured. As the ferromagnetic ring passes through the region of the coil and/or the air gap, a short circuit results in the magnetic circuit, the field strength increases, and therefore a pulse-like current change may be detected. Since the measurement baseline and/or the ferromagnetic ring has only a small dimension in the axial direction, the pulse-like change is of a short duration. This device for performing the V0 measurement is bound to the barrel, and the measurement method performed with it may only be implemented if special projectiles, specifically those having ferromagnetic rings, are used.

It is thus the object of the present invention to suggest a device and a method for performing the V0 measurement, using which the disadvantages of the known single-coil and double-coil devices are avoided.

This object is achieved according to the present invention for the device and for the method by a coil placed along a longitudinal axis of the weapon barrel, a supply device which impresses a current in the coil and an analysis device which calculates muzzle velocity based upon a voltage pulse from the coil due to the passage of the projectile through a magnetic field produced by the coil.

The object is achieved by a method in which a coil is positioned along a longitudinal axis of the weapon barrel, and by feeding current through the coil, the muzzle velocity is determined from a voltage pulse in the coil when the projectile passes through a magnetic field of the coil.

The obviously most important feature, through which the novel device differs from the known double-coil devices described above, is that only one single coil is necessary. In the novel device, which does not form a barrier, signals of only one single coil are available, so that a novel method is also used for analyzing the data provided by the coil.

The coil does not press against the outside of the weapon barrel, but rather is positioned after the muzzle cross-section of the weapon barrel, viewed in the movement direction of the projectile. The temperatures are so low there that coils having copper windings may be used. The positioning of the coil after the muzzle cross-section also has the advantage that the magnetic field is not influenced by the barrel. The frequency of the corresponding signal is therefore smaller and better results are achieved in the analysis.

The novel device having only one coil is significantly shorter than the known double-coil devices, and it is also correspondingly lighter. The outlay for further devices is reduced in comparison to the related art, since only one analysis channel is necessary for the analysis. The danger of damaging the coils is greatly reduced, since no coil must be positioned at a relatively large distance from the weapon barrel muzzle.

The novel method is such that no measurement baseline is necessary on the device. The device is therefore also well suitable for relatively long projectiles, for subcaliber shells, for example.

The precision of the novel method is, with appropriately high manufacturing precision of all parts, sufficient for any practical use. Insignificant inaccuracies may be caused in that the magnetic field generated is not completely constant, and the projectiles, which on their part form parameters for the V0 measurement, may always differ from one another by a little. A muzzle brake acts after the projectile leaves the weapon barrel, through which unknown minimal movements arise that may cause a superposition of the measurement signal provided.

### BRIEF DESCRIPTION OF THE DRAWINGS

Details and advantages of the present invention will be described in detail in the following on the basis of exemplary embodiments and with reference to the drawing.

FIG. 1 shows a weapon barrel having a device according to the present invention, in a simplified, schematic illustration;

FIG. 2 shows, in the left half of the figure, three partial figures, each having a projectile upon exiting the weapon barrel in three different positions and/or at three sequential points in time, and, in the right half of the figure, the curve of the voltage as a function of time during passage of the projectile through a coil of the device according to the present invention;

FIG. 3 shows a first exemplary embodiment of the device according to the present invention, the analysis of the variables provided by the coil being performed in an analog way, shown as a circuit diagram; and

FIG. 4 shows a second exemplary embodiment of the device according to the present invention, the analysis of the variables provided by the coil being performed digitally, in the same illustration as in FIG. 3.

### DESCRIPTION OF THE PREFERRED EMBODIMENTS

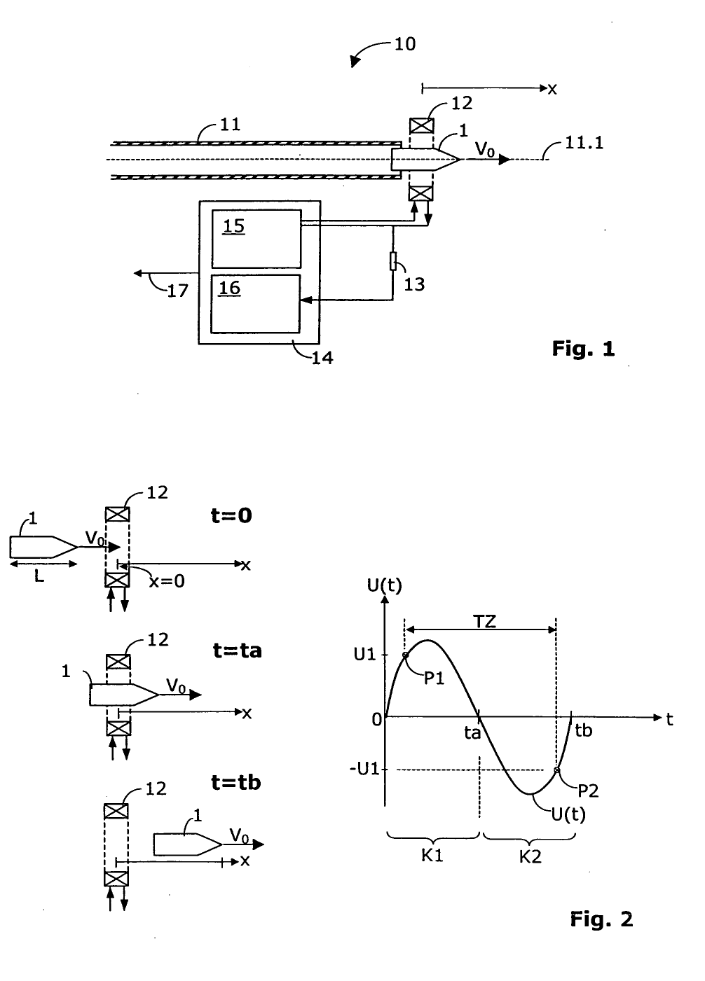

An embodiment of the present invention and the function of the method according to the present invention will be described with reference to FIG. 1. In FIG. 1, a device 10 for determining the V0 velocity of a projectile 1 upon exiting a weapon barrel 11 is shown. The device 10 includes a coil 12, which has a winding, and which is positioned around a longitudinal axis 11.1 of the weapon barrel 11 in the region of the exit. The winding of the coil 12 may, depending on the embodiment, include one or more turns. A supply device 15 is provided in order to impress a constant current I in the winding of the coil 12. The current I, which flows through the winding of the coil 12, generates a magnetic field H in the surroundings of the coil 12. This magnetic field H is disturbed, and thus changed, as the projectile 1 passes through the coil 12. Using an appropriate analysis, as will be derived in the following, a reliable and precise statement may be made about the V0 velocity from the disturbance and/or change of the magnetic field H.

The projectile 1 induces a voltage U(t) in the winding of the coil 12 as it passes through the coil 12. This induced voltage U(t) may be determined as follows:

$$U ( t ) = - N \frac{ⅆ Φ}{ⅆ t} = - N \frac{ⅆ Φ}{ⅆ x} \frac{ⅆ x}{ⅆ t} = - N \frac{ⅆ Φ}{ⅆ x} V0 \qquad ( 1 )$$

In the formula:

N: number of the turns of the winding of the coil 12 [−];

x: distance covered by the shell in the firing direction [m];

V0: muzzle velocity, also referred to as V0 velocity, [m/s];

φ: magnetic flux [volt sec.].

The flux change over time dΦ/dx is proportional to the change of the magnetic field strength dH(x)/dx, which may be determined approximatively as follows with the aid of the law of Biot and Savart:

$$\frac{ⅆ Φ}{ⅆ x} = \frac{{DG}^{2} \cdot π}{4} μ0 \cdot μ r \frac{ⅆ H ( x )}{ⅆ x} \qquad ( 2 )$$

In the formula:

DG: diameter of the projectile 1 [m];

μ0: induction constant [H/m=Vs/Am];

μr: permeability;

H: magnetic field strength [A/m];

For H(x), the Biot-Savart law leads to:

$$H ( x ) = \frac{I \cdot {D}^{2} \cdot N}{8 \cdot {[ {x}^{2} + {[ \frac{D}{2} ]}^{2} ]}^{3 / 2}} \qquad ( 3 )$$

In the formula:

D: diameter of the coil 12 [m]

I: current through the coil 12 [A]

If the equation (3) is differentiated for x, the change of the magnetic field strength follows as a function of x:

$$\frac{ⅆ H ( x )}{ⅆ x} = \frac{I \cdot {D}^{2} \cdot N}{8} x \cdot {3 [ {x}^{2} + {[ \frac{D}{2} ]}^{2} ]}^{- 5 / 2} \qquad ( 4 )$$

The following expression for the relationship for the induced voltage U(t) during the passage of the projectile 1 through the coil 12 results from the equations (1), (2), and (4):

$$U ( t ) = VK \frac{{DG}^{2} π}{4} μ0 \cdot μ r \frac{{ID}^{2} {N}^{2}}{8} x \cdot {3 [ {x}^{2} + {[ \frac{D}{2} ]}^{2} ]}^{- 5 / 2} \qquad ( 5 )$$

In this formula:

K: voltage reduction because of the eddy currents arising in the housing of the projectile 1

The meaning of the equations derived above will now be explained with reference to FIG. 2. The equation (4) is particularly decisive for explaining the voltage curve U(t):

If x=0:

The projectile 1 is located, viewed in the movement direction, in the middle of the coil 12 and/or the central cross-section of the projectile 1 lies, viewed in the movement direction, in the central cross-section of the coil 12 and the voltage U(t) induced in the coil 12 is zero. This is the case at time t=ta.

If x<0:

The projectile 1 is located, viewed in the movement direction, left of the middle of the coil 12 and plunges into the coil 12 at velocity V0. The induced voltage U(t) increases continuously with increasing x and reaches a maximum value. The voltage U(t) then falls again and has a zero passage at x=0, when the projectile 1 is located in the middle of the coil 12.

If x>0:

The projectile 1 is located to the right of the middle of the coil 12 and the induced voltage U(t) falls continuously with increasing x and reaches a minimum value. If the projectile 1 moves further out of the coil 12, the induced voltage U(t) increases again and approaches 0 V at large values of x.

The curve of the induced voltage U(t) may be calculated approximatively using the equation (5). In the above observation, the eddy currents which build up in the mantle of the projectile 1 during the passage of the projectile 1 through the coil 12, and which generate a counter field, were not taken into consideration. This counter field attenuates the original field and reduces the amplitude of the induced voltage U(t) in the coil 12. This voltage reduction is taken into consideration in the equation (5) by the variable K. The variable K and/or here the factor K is referred to as a correlation variable and may be determined experimentally and/or using a computer according to the present invention. Each projectile type has a different correlation variable K which is characteristic to it, or, in other words, the correlation variable K characterizes the projectile type. If which projectile type is fired is known beforehand, a statement about the V0 velocity of the projectile 1 may then be made on the basis of the induced voltage U(t). The derivation of the V0 velocity is explained in the following.

To calculate the V0 velocity, the length of a delay time interval TZ is measured, starting from a start point P1 shown in FIG. 2, at which the amplitude of the induced voltage U(t)=+U1. As soon as the amplitude at the induced voltage U(t) has reached the value −U1, the time measurement is stopped.

Therefore, the following two equations (6) and (7) apply for determining x1 and x2.

$$\begin{matrix}V0 \cdot K \cdot \frac{{DG}^{2} \cdot π}{4} μ0 \cdot μ r \frac{I \cdot {D}^{2} \cdot {N}^{2}}{8} \cdot x1 \cdot {3 [ {x1}^{2} + {[ \frac{D}{2} ]}^{2} ]}^{- 5 / 2} - U1 = 0 & ( 6 ) \\ V0 \cdot K \cdot \frac{{DG}^{2} \cdot π}{4} μ0 \cdot μ r \frac{I \cdot {D}^{2} \cdot {N}^{2}}{8} \cdot x2 \cdot {3 [ {x2}^{2} + {[ \frac{D}{2} ]}^{2} ]}^{- 5 / 2} + U2 = 0 & ( 7 )\end{matrix}$$

In addition:

$$V0 = \frac{x2 - x1}{TZ} \qquad ( 8 )$$

The desired values of V0, x1, and x2 result from the system of equations of the three equations (6), (7), and (8).

This theoretical derivation will now be applied to the exemplary embodiment of FIGS. 1 and 2.

As the projectile 1 passes through the magnetic field H of the coil 12, a voltage pulse U(t) is induced, as shown in FIG. 2. The duration of the voltage pulse U(t) is correlated with the V0 velocity and the length L of the projectile 1. An analysis device 16 is provided, which reads off the voltage pulse U(t) on the winding. In order to now be able to make a statement about the V0 velocity, two points P1, P2 of the voltage pulse U(t) are predetermined and the time interval TZ from point P1 to point P2 is determined. The V0 velocity of the projectile 1 is calculated from the time interval TZ. In this calculation, the correlation variable K, which is specific to the projectile type fired, is taken into consideration.

The time interval TZ is a function of, among other things, the following influencing variables:

length L of the projectile 1;

diameter DG of the projectile 1;

material and composition (e.g., permeability μr) of the projectile 1;

coil current I;

construction of the coil 12;

arrangement of the coil 12 in relation to weapon barrel 11.

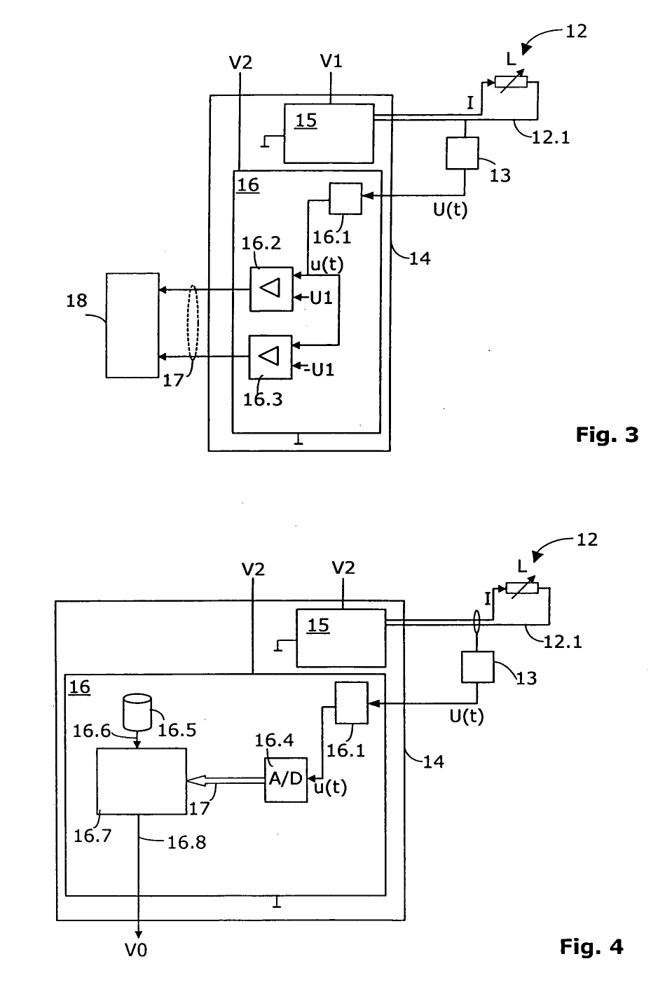

A first exemplary embodiment of a suitable analysis device 16 is shown in FIG. 3. The illustration shows a schematic block diagram. Details of the block diagram, such as the selection and dimensioning of the concrete components, are a function of the embodiment of the present invention selected. In the exemplary embodiment shown, a supply device 15, implemented as a constant current source, powers the coil 12, which is additionally identified with L here, using a constant coil current I. For this purpose, a supply voltage V1 is applied to the supply device and/or constant current source 15. On one side of the coil winding 12.1, the induced voltage U(t) is read off using a suitable decoupling 13. The decoupling 13 may be formed, for example, by a resistor R and/or a coil L1 having a network made of different partial elements. The voltage U(t) is fed to a device for measured signal preparation 16.1, which includes an impedance transformer and/or an amplifier, for example. Further components may also be provided here, in order to filter the signal U(t), for example. The output signal u(t) of the measured signal preparation device is fed to two comparators 16.2 and 16.3 in the embodiment shown. The first comparator 16.2 compares the voltage u(t) to a first reference voltage U1 and the second comparator 16.3 compares the voltage u(t) to a second reference voltage −U1. In this example, the reference voltages are placed symmetrically in relation to the axis U=0. The reference voltages may, however, also have different values (e.g., +U1 and −U2).

Two TTL pulses, or other variables, which are correlated with the time interval TZ, may be fed via a connection 17 to an analysis and/or circuit logic 18 (e.g., an FPGA; field programmable array), for example. During the analysis, which may be analog or digital, the velocity V0 is then established on the basis of the time interval TZ and the correlation variable K.

In FIG. 2, a simplified curve of voltage U(t) over time t is given on the right side. The voltage curve has a first curve section K1 in the positive voltage range, a zero passage at t=ta, and a second curve section K2 in the negative voltage range. The voltage increases from 0 V the further the projectile 1 penetrates into the magnetic field of the coil 12. The voltage U(t) then reaches a maximum and subsequently falls again until the zero passage. The time of the zero passage is identified with t=ta. From time t=ta on, the voltage falls further and reaches a minimum. When the projectile 1 exits the magnetic field of the coil 12, the induced voltage U(t) is again reduced to 0 V. The time at which the induced voltage U(t) again reaches the value 0 is identified with tb.

The curve U(t) shown in FIG. 2 is characteristic for a specific projectile type, it being noted that this is a strongly schematic curve. The two points P1 and P2 are fixed, and in the example shown the point P1 is fixed in the rising branch of the first curve section K2 and the point P2 is fixed in the rising branch of the second curve section K2. In this example, the two points P1 and P2 are placed symmetrically in relation to the induced voltage, i.e., U(P1)=−U(P2).

The points P1 and P2 are preferably fixed in such a way that they lie in the region of the greatest increase of the curve U(t). These points may be found by producing the second derivative of the curve U(t) and thus searching for the maxima of the slope. Specifically, if the points P1 and P2 are selected in the steep region of the curve U(t), the time interval TZ may be determined more precisely than if the points lay in the regions of the curve U(t) in which the curve had only a slight slope.

A further exemplary embodiment of a suitable analysis device is shown in FIG. 4. A constant current source 15 supplies the coil 12 with a constant coil current I. For this purpose, a supply voltage V2 is applied to the constant current source 15. The induced voltage U(t) is read off. The voltage U(t) is fed to a device for measured signal preparation, which includes an amplifier 16.1 and/or an impedance transformer in the embodiment shown. Further components may also be provided here, in order to filter the signal U(t), for example. The amplifier 16.1 provides an amplified signal u(t), which is converted by an analog-digital converter 16.4 into a digital signal. The digital signal is fed via a bus 17 to a processing device 16.7, such as a computer. The processing device 16.7 obtains information about the type of the projectile 1 fired from a memory 16.5 or from a register and/or table. This information is provided via a connection 16.6. The shape of the curve U(t) applying for the current projectile type fired and the position of the points P1 and P2 may be transmitted to the processing device 16.7, for example. The correlation variable K may also be provided via the connection 16.6. The processing device 16.7 then determines the time interval TZ and, using the correlation variable K, also the muzzle velocity V0 of the projectile 1 from the information.

The processing device 16.7 may receive information about the projectile type to be fired transmitted from a main computer or a measurement device.

According to the present invention, the projectile 1 itself is used as the measurement baseline. Separate coils, which are positioned at a distance to one another and thus form a measurement baseline, and which the projectile flies through one after another to make a start-stop time measurement according to the barrier principle, are no longer necessary.

It is an advantage of the present invention that there are no longer two coils which may mutually influence one another. Since, according to the present invention, one operates with only one coil, as noted above, the length of the V0 measurement device is significantly shorter than in previous achievements of the object.

It is a further advantage of the present invention, as also noted above, that one manages to make the V0 measurement using only one measurement channel.

A device having only one coil is less susceptible to breakdown.

What is claimed is:

1. A device for determining the muzzle velocity of a projectile upon exiting a weapon barrel, comprising:
a coil, which is positioned along a longitudinal axis of the weapon barrel in the region before the exit,
a supply device for impressing a current in the coil, in order to generate a magnetic field,
an analysis device, which
i. reads a voltage pulse in the coil, which is induced during the passage of the projectile through the magnetic field of the coil and whose duration is correlated with the muzzle velocity and the length of the projectile,
ii. detects two predetermined points of the voltage pulse,
iii. determines the time interval between the two points, and
iv. calculates the muzzle velocity of the projectile from the time interval,

2. The device according to claim 1, characterized in that the analysis device includes a comparator circuit, which, upon detection of a first point of the two predetermined points, outputs a first pulse, and, upon detection of the second point of the two predetermined points, outputs a second pulse, the time interval corresponding to the duration between the first pulse and the second pulse and the pulses preferably being TTL signals.

3. The device according to claim 2, characterized in that the comparator circuit, upon detecting the first point of the two predetermined points, performs a comparison to the voltage amplitude of a first threshold value and, upon detecting the second point of the two predetermined points, performs a comparison to the voltage amplitude of a second threshold value.

4. The device according to claim 1, characterized in that the supply device includes a constant current source.

5. The device according to claim 1, characterized in that the analysis device includes an analog-digital converter to sample the voltage pulse and convert it into digital values.

6. The device according to claim 4, characterized in that the analysis device includes a digital processing device, which detects the two predetermined points of the voltage pulse by analyzing corresponding digital values through a comparison with stored, predetermined values.

7. The device according to claim 1, characterized in that the analysis device includes time measurement means, in order to be able to determine the time interval of the two points.

8. The device according to claim 1, characterized in that the curve of the voltage pulse and the position of the predetermined points are a function of the type of the projectile and are preferably predetermined in a memory, in a register, or in a table.

9. The device according to claim 8, characterized in that the analysis device receives information about the projectile to be fired transmitted from a main computer or from a measurement device.

10. The device according to claim 1, characterized in that the voltage pulse has a first curve section, a zero crossing, and a second curve section, the zero crossing being correlated with the time, at which the projectile is located centrally in the coil.

11. The device according to claim 10, characterized in that the first point of the two predetermined points is in the region of the first curve section and the second point of the two predetermined points is in the region of the second curve section.

12. The device according to claim 1, characterized in that the voltage pulse has a curve which is a function of the coil diameter, the dimensions of the projectile, the permeability of the projectile, and the current.

13. The device according to claim 1, characterized in that there is a predeterminable correlation variable between the muzzle velocity of the projectile and the time interval of the two points, which is used in the calculation of the muzzle velocity.

14. The device according to claim 1, characterized in that the analysis device includes means, performing an equalization calculation between the muzzle velocity and the time interval for each new type of the projectile.

15. A method for determining the muzzle velocity of a projectile upon exiting a weapon barrel, a coil being positioned along a longitudinal axis of the weapon barrel in the region of the exit, and the following steps being executed:
feeding a current into the coil in order to generate a magnetic field,
moving the projectile through the magnetic field of the coil,
reading off a voltage pulse, which is induced during the passage of the projectile through the magnetic field of the coil and whose duration is correlated with the muzzle velocity and the length of the projectile,
determining the time interval between two points of the voltage pulse, the points being predetermined,
providing a correlation variable, which is characteristic for the type of the projectile,
determining the muzzle velocity of the projectile (1) using the correlation variable and the time interval.

16. The method according to claim 15, characterized in that the type of the projectile is recognized automatically or input manually.

17. The method according to claim 15, characterized in that, before establishing the time interval, the voltage pulse is subjected to an analog-digital conversion.

18. The method according to claim 16, characterized in that, before establishing the time interval, the voltage pulse is subjected to an analog-digital conversion.
